(19) United States
(12) Patent Application Publication
(10) Pub. No.: US 2005/0263596 A1
(43) Pub. Date: Dec. 1, 2005

(54) Portable charger, including portable sleeve, for an electronically readable card

(75) Inventors: Craig R. Nelson, Melbourne, FL (US); Robert W. Singleton, Plant City, FL (US)

Correspondence Address: FOLEY AND LARDNER;SUITE 500, 3000 K STREET NW, WASHINGTON, DC, 20007, US

(73) Assignee: Solicore, Inc.

(21) Appl. No.: 11/127,299

(22) Filed: May 12, 2005

Related U.S. Application Data
(60) Provisional application No. 60/570,097, filed on May 12, 2004.

(51) Int. Cl. G06K 7/06

(52) U.S. Cl. 235/441

(57) ABSTRACT

Convenient, portable chargers for recharging a secondary battery in an electronically readable card which can be in sleeve form. The portable chargers are lightweight and portable and desirably have dimensions that are not much larger than those of an electronically readable card. The chargers may include a connector such as a sleeve for securing an electronically readable card, a power source for providing recharging power and a power interface for delivering the recharging power from the power source to the electronically readable card. The power source may take on a variety of forms including another battery, a photovoltaic array or a direct plug connection to a electric wall outlet, Universal Serial Bus port or a telephone jack. In some embodiments the portable chargers charge the battery in an electronically readable card by inductive coupling.

### BACKGROUND

Electronically readable cards, such as integrated circuit cards or Smart Cards, have recently become widely used across many sectors of the economy. For example, such cards have been used to conduct transactions and exchange and monitor information in the fields of banking, security, transportation and health care. These electronically readable cards, which are typically about the size of a standard credit card, include, at a minimum, a microprocessor, a memory and an interface for communicating with an external system. Cards can also include, for example, magnetic stripes and embossing areas. Electronically readable cards are now subject to standardizations including the ISO/IEC 7816 and 14443 series of standards for contact and contactless forms of the cards. See, for example, U.S. Pat. No. 6,694,399 (“Method and Device for Universal Serial Bus Smart Card Traffic”).

In order to extract information from or exchange information with an electronically readable card, the card components generally require a source of power. Many electronically readable cards are designed to be powered only when they are coupled to a power source from an external device, such as a card reader, a security authorization device, a teller machine or a point of sale device. A significant drawback of these designs is that information on the card cannot be accessed when the card is removed from the device. Thus, a card holder who wants to retrieve information, such as a bank balance, from the card may be unable to do so when such devices are not available. Moreover, card readers are designed to house the various components associated with information retrieval and display and include bulky conventional power sources such as batteries or electrical cords for plugging into wall sockets. For this reason the card readers are not nearly as small and portable as the cards themselves. As a result, a card holder who desires the convenience of a card reader device on the go, may have to carry a large bag or case.

Other electronically readable cards have incorporated a power source, typically a primary or secondary battery, into the card itself. The use of primary batteries can be less practical because they can require either replacement of the battery or the entire card once the battery runs dry. Secondary batteries generally are more practical. Unfortunately, there are currently few options for charging these batteries on the go. To alleviate this problem, larger secondary batteries may be used. However, these larger batteries increase the weight and thickness of the cards and reduce card flexibility. This is particularly true for cards which incorporate components, such as biometric sensors, which draw large currents. A need exists to improve the devices which will promote use of rechargeable batteries which are light and small.

Recently, electronically readable cards that incorporate a power supply for recharging a secondary battery have been designed. For example, electronically readable cards having integrated solar cells for recharging a battery in the card have been proposed. A disadvantage of integrating a charging power source, such as solar cells, into the card itself is that they can have limited power based on the available area.

Although many convenient and portable charging devices are available for small electronic devices such as cell phones, computers and calculators, such devices have not yet been provided for electronically readable cards, particularly those having rechargeable batteries.

Thus, a need exists for a small, portable, versatile battery charging device for use with electronically readable cards, particularly those having rechargeable batteries.

### SUMMARY

Portable battery chargers for recharging a secondary battery in an electronically readable card are provided. The chargers are small and lightweight and generally make conventional battery charging technologies, such as those presently available for small electronic devices available for electronically readable cards. In a preferred embodiment, the portable battery charger is in the form of a sleeve or enveloping jacket which provides power to the electronically readable card. In a preferred embodiment, the sleeve is generally the same shape as but somewhat larger than the electronically readable card and neatly covers the electronically readable card. In a preferred embodiment, the portable battery charger can be conveniently carried around in clothing and apparel such as wallets and pockets. In a preferred embodiment, the electronically readable card is shaped like a standard commercial banking or credit card. The electronically readable card can slip into the portable battery charger. Power, data, or both can be transferred from the portable battery charger to the electronically readable card, or vice versa.

The portable battery charger generally includes a connector for connecting the charger to an electronically readable card and a power source for supplying the power to recharge a secondary battery in an electronically readable card. The connector can be in the form of a generally rectangular-shaped sleeve structure in a preferred embodiment. The portable battery charger, which preferably is in the form of a sleeve, may provide power to the secondary battery of an electronically readable card through a direct contact type interface or through an indirect contactless interface.

When a contact type interface is used, the connector typically includes a mechanism, such as a slot, clamp, or base, for securing an electronically readable card and one or more electrical contacts for bringing the connector into electrical communication with the card. A power interface for delivering power from the power source to the connector may also be provided. The power source may be mounted directly to or embedded in the connector or may be remotely connected to the connector, for example using electric cables, wires, circuitry, and the like. Electronically readable cards for use with these portable chargers include a secondary battery, one or more electrical contact pads and a power interface for delivering the recharging power from the contact pads to the secondary battery. When the electronically readable card is secured by the connector, the one or more electrical contacts on the connector are in electrical communication with the contact pads on the card. The contact pad can be a contact surface and is not meant to limit the pads to any particular shape. For example, the pads may take the form of pins, strips and the like.

When a contactless interface is used the power source is adapted to be in inductive communication with the secondary battery of an electronically readable card when the electronically readable card is held by the connector. In these embodiments the connector serves to keep the electronically readable card in close enough proximity to the power source to allow for inductive charging of the secondary battery in the electronically readable card. A loop antenna can be used to inductively couple the connector to the card's built in antenna.

The connector may have a variety of geometries, provided it is capable of securing an electronically readable card. For example, the connector may be a sleeve which defines an internal slot. In this embodiment an electronically readable card may be slid at least partially into the slot such that it is wholly or partially housed within the sleeve. Alternatively, the connector may define a slot between two prongs of a clip, such that an electronically readable card may be pinched between the prongs along one edge. The prongs may be rigidly fixed to a base or may be hinged together to provide a clamp. In another exemplary embodiment, the connector is a base plate having a surface onto which the electronically readable card may be snapped or otherwise secured.

The placement of electrical contacts on a given connector will depend on the geometry of that connector. However, the electrical contacts will be positioned and designed to engage matching contact pads on an electronically readable card when that card is secured by the connector. For example, a connector sleeve may include one or more electrical contacts within its slot that are positioned to make electrical contact with one or more contact pads on an electronically readable card when that electronically readable card is disposed within the slot. Alternatively, a connector clip may include one or more electrical contacts that are pressed onto matching electrical contact pads along the edge of an electronically readable card when the clip clamps onto the electronically readable card. A base plate connector may be characterized by a connection surface having one or more electrical contacts that engage matching contact pads on an electronically readable card when that card is secured to the base plate.

Power sources that may be included when a contact type interface is provided between a portable charger and electronically readable card include, but are not limited to, batteries, photovoltaic cells and remote power outlets, such as a standard 110 V wall socket, a USB port, supercapacitor, or a telephone jack. When these types of power sources are employed the charger provides electrical communication between the power source and the secondary battery of an electronically readable card. If the power source is a battery or one or more photovoltaic cells, the battery or photovoltaic cells may be incorporated into or onto the connector. If the power source is a remote power outlet the connector may include a plug or socket and/or a power cord for connecting the connector to the outlet.

Power sources that may be included when a contactless interface is provided between a portable charger and electronically readable card include, inductive coils. In these embodiments a primary coil is mounted on or otherwise attached to a connector, such as a clip, sleeve or base plate. This primary coil is electrically connected to a power amplifier and a power connection that may be plugged into a power outlet (e.g. an AC power outlet). Electronically readable cards to be charged with such a portable charger incorporate a secondary coil electrically connected to a rectifier circuit, the output of which is in electrical communication with a secondary battery in the electronically readable card. When the electronically readable card is secured to the connector, the primary and secondary coils are placed in close proximity and become inductively coupled, such that amplified signals from the primary coil induce corresponding signals in the secondary coil.

A power interface may be provided between the power source and the electrical contacts on the connector for monitoring and/or controlling the flow of power from the power source to the contacts. The power interface may include circuitry for monitoring and/or limiting the current from the power source to the contacts and/or a voltage converter. Larger current draw components can be put onto the connector. They can also be put on the electronically readable card.

The system can be adapted so that RFID components can be used in either the electronically readable card, the connector, or both.

Optionally, a biometric sensor such as a fingerprint sensor may be associated with the connector, the electronically readable card, or both. In one embodiment, the invention provides a portable biometric sensor device for an electronically readable card which comprises a connector securing and recharging an electronically readable card; a biometric sensor, and a communication interface for transmitting a signal between the biometric sensor and an electronically readable card when the electronically readable card is secured by the connector. In one embodiment, the connector is adapted so that a biometric sensor can be also used in the electronically readable card and data can be fed to the card. The biometric sensor, which can be a large power draw and can be on the connector or on the card, can be powered by the connector, the card, or both.

The portable charger can be cosmetically adapted for excellent appearance with colors and logos suitable to male or female tastes. If desired, they can be limited in function so they focus on recharging, or they can be combined with other functions of card readers and include, for example, matrix or digital display elements and data transfer functions.

### BRIEF DESCRIPTION OF THE DRAWINGS

FIG. 1 shows a portable charger having a connector sleeve and a USB plug.

FIG. 2 shows an electronically readable card that may be charged with the portable charger of FIG. 1.

FIG. 3 shows a portable charger having a connector sleeve, a battery power source, and a fingerprint sensor.

FIG. 4 shows a portable charger having a base plate connector wherein photovoltaic cells serve as a power source.

FIG. 5 shows an electronically readable card that may be charged with the portable charger of FIG. 4.

FIG. 6 shows a typical recharging circuit that may be used with power sources, such as those shown in FIGS. 4 and 8.

FIG. 7 shows a portable charger having a connector sleeve and a wireless, inductively coupled charging interface.

FIG. 8 shows an electronically readable card that may be charged with the portable charger of FIG. 7.

FIG. 9 shows an exemplary mock-up version of the portable charger together with the electronically readable card.

FIG. 10 shows an exemplary mock-up version of the portable charger.

FIG. 11 shows an exemplary mock-up version of the portable charger adapted to have a standard USB connection.

### DETAILED DESCRIPTION

A portable battery charger for an electronically readable card is provided, preferably, in the form of a sleeve which neatly at least partly covers the electronically readable card. The charger can comprise a connector, preferably in the form of a sleeve, to which an electronically readable card may be secured and includes a power source that is in electrical communication with a secondary battery in the card when the card is secured by the connector. The chargers are typically small and lightweight and, in some instances may be easily transported in a wallet, shirt pocket, pants pocket, or small purse. It can be placed into a neatly marketed cover to hold it and protect it. The cover can fold on itself for example.

The portable battery chargers are desirably much smaller and more convenient than chargers that are associated with and incorporated into bulky card reader/writer devices, such as electronic teller machines, point-of-sale devices and the like. In one embodiment, the charger can provide other functions besides recharging the battery in the electronically readable card. In one embodiment, however, the primary purpose of the charger is to recharge the battery in the electronically readable card. In one embodiment, the exclusive purpose of the charger is to recharge the battery in the electronically readable card. For example in some embodiments, the portable battery chargers provided herein do not have computer processing units, memories and/or computer hardware attached to them. This streamlines the chargers, making them compact and lightweight. In some embodiments, the portable battery chargers do not even have display units or input devices such as keypads attached to them. Instead, these portable chargers include only those electronic components necessary to enable them to recharge the secondary battery in an electronically readable card. A basic and novel feature of the invention is that the circuitry and other components of the portable charger, connector, and power source can be adapted for recharging a secondary battery in the electronically readable card and that the portable charger and its components can be engineered for that primary purpose.

Description of Electronically Readable Cards

Electronically readable cards, such as Smart Cards, (generally small flexible cards, e.g. plastic cards about the size of a credit card), having a microprocessing unit, a memory and an interface for transmitting and receiving data from an external source. A typical electronically readable card includes a processor coupled to an electrically erasable programmable read-only memory (EEPROM), read only memory (ROM) and/or random access memory (RAM). These components are fabricated onto a single integrated chip which further includes a microprocessor which is used to execute instructions and store data in the memory. Electronically readable cards further include an input/output (I/O) signal interface for exchanging I/O signals between the electronically readable card and an external device. The I/O signal interface may be composed of electrical contacts that physically connect the card to an external device. Alternatively, the I/O signal interface may be a wireless interface, such as a radiofrequency (RF) or infrared (IR) interface, that provides a contactless connection between the card and an external device. The electronically readable cards may also optionally include various input devices, such as a keypad, and displays. An example of an electronically readable card which may be used with the chargers provided herein is described in U.S. patent application Ser. No. 10/437,546, filed May 13, 2003 to Wensley et al. (“Card With Embedded IC and Electrochemical Cell”), which is hereby incorporated by reference in their entirety and can be used for the practice of the present invention.

In addition to the components described above, electronically readable cards for use with the portable chargers provided herein can include an on-board rechargeable battery. The battery is desirably a thin, flexible battery that adds little weight and thickness to the card and does not significantly negatively affect card flexibility. Suitable secondary batteries that may be incorporated into the electronically readable cards include, but are not limited to, polymer batteries, lithium ion batteries, lithium metal batteries and metal-sulfur batteries. Examples of suitable lithium metal and lithium ion batteries that may be incorporated into the cards include those disclosed in U.S. Pat. Nos. 5,888,672 and 6,451,480 to Gustafson et al., as well as pending U.S. patent application Ser. Nos. 10/437,778; 10/437,559; and 10/437,546, all filed May 13, 2003 to Wensley et al., which are hereby incorporated by reference in their entirety and can be used for the practice of the present invention. Batteries are preferred which can withstand pressures and temperatures of Smart Card lamination are preferred. Batteries which comprise polymer matrix electrolytes (PMEs) based on polyimides are preferred, wherein the polyimides are soluble in solvents but have high glass transition temperature.

The electronically readable card can further comprise, if desired, a biometric sensor which can be powered from the sleeve, from the card, or both.

The electronically readable card can be adapted to work and interface with conventional standards in the industry such as, for example, ISO 7816 (contact interfaces) and ISO 14443 (contactless interfaces). See, for example, references to these standards in U.S. Pat. Nos. 6,705,520; 6,576,991; 6,568,600; 6,466,126; 6,257,486; 6,219,439; 6,202,927; 6,161,762; and 6,101,477, each of which are incorporated by reference in their entirety.

Connectors, Generally:

The design of the connector may depend, at least in part, on the shape and size of the electronically readable card with which it is intended to be used. Generally, the connector will be small, lightweight, and separate from any bulky external devices. Standard contact and contactless configurations can be adapted. In a preferred embodiment, described in the next section, the connector is in the form of a sleeve. In addition, however, the connector, for example, may be as simple as a clip that pinches an electronically readable card between two or more prongs. The clip may be designed to pinch an electronically readable card along at least a portion of one edge. In another exemplary embodiment, the connector is a base plate having a connection surface onto which the electronically readable card may be snapped or otherwise secured. The base plate may optionally include a cover that is disposed over the electronically readable card when the card is secured to the base plate. The cover may serve to protect the card during the charging operation and may also serve as a surface for mounting or embedding a power source, such as a battery or a photovoltaic cell or for mounting or embedding a biometric sensor, such as a fingerprint sensor.

Sleeve Type Connectors:

In a preferred embodiment, the connector may be a sleeve which defines an internal slot. The connector can be generally rectangular, wherein its length and width are much greater than its height, much like a standard Smart Card. The slot can be also rectangular and coplanar with the sleeve. The slot can be adapted if desired to provide a reversible locking of the card. In this embodiment an electronically readable card may be slid at least partially into the slot, or wholly into the slot, such that it is wholly or partially housed within the sleeve. These sleeve connectors may be lightweight, desirably flexible and opaque. Optionally, they can be at least partially transparent. A transparent or at least partially transparent sleeve can be desirable because is allows the user to view an electronically readable card display.

The sleeve can be made of conventional materials such as plastics or metals, and the selection of the material can be adapted for a given application. A housing can be configured which, from a cross-sectional view point, can entirely surround the electronically readable card or only partially surround the electronically readable card. In other words, there can be at least one gap, slit, or other opening in the housing as long as the card can be mechanically disposed into the sleeve and functionally be recharged by the sleeve.

The sleeves are relatively thin and compact, desirably having a size that is not much greater than the electronically readable card that it is designed to charge. For example, the sleeve can have dimensions which provide it with a volume ratio compared to the volume of the electronically readable card. This volume ratio can be, for example 10:1 or less, or 5:1 or less, or 4:1 or less, or 2:1 or less, or 1.5:1 or less, or 1.25:1 or less. In some designs, the sleeve is small enough to be transported in the card holder's wallet or card carrying device. The ratio of sleeve length to card length can be also small. For example, length ratio can be 2:1 or less, 1.5:1 or less, or 1.3:1 or less. The ratio of sleeve width to card width can be also small. For example, width ratio can be 2:1 or less, 1.5:1 or less, or 1.3:1 or less. The ratio of sleeve height to card height can be also small. For example, height ratio can be 2:1 or less, 1.5:1 or less, or 1.3:1 or less. Conventional Smart Card dimensions can be used. For example, in some embodiments the sleeves have a thickness of no more than about 10 mm. This includes embodiments where the sleeves have a thickness of no more than about 8 mm, further includes embodiments where the sleeves have a thickness of no more than about 5 mm, and still further includes embodiments where the sleeves have a thickness of no more than about 4 mm, and still further includes embodiments where the sleeves have a thickness of no more than about 3 mm. The length and width of the sleeve is also desirably not much greater than that of the electronically readable card. For example, in some embodiments the sleeves have a width of no more than about 10 cm. This includes embodiments where the sleeves have a width of no more than about 8 cm, further includes embodiments where the sleeves have a width of no more than about 7 cm and still further includes embodiments where the sleeves have a width of no more than about 6 cm Finally, in some embodiments the sleeves have a length of no more than about 15 cm. This includes embodiments where the sleeves have a length of no more than about 12 cm, further includes embodiments where the sleeves have a length of no more than about 10 cm and still further includes embodiments where the sleeves have a length of no more than about 9 cm. The total perimeter of the sleeve can be, for example, about 50 cm or less, but preferably is more suitable for wallets, and can be for example about 40 cm or less, or more preferably about 30 cm or less.

The sleeves are generally composed of a sleeve-like housing that defines a slot adapted to accept an electronically readable card. The slot may be dimensioned such that the electronically readable card may be fully or only partially inserted therein. Typically, the housing will be formed from a plastic, desirably a flexible and/or transparent plastic. In some embodiments the power source, such as a battery or a photovoltaic cell, of the portable charger is integrated into the housing and one or more electrical contacts are disposed within the slot and positioned to engage matching contact pads on an electronically readable card when that card is inserted into the slot. Standard forms of contact with the electronically readable card can be used including the ISO/IEC standards noted above (7816-2 defines dimensions and locations of contacts; face and edge contacts can be used). In addition to charging the battery in an electronically readable card, the power source of the charger may be used to directly power other electronically readable card components.

Power Sources—Embedded or Mounted to the Connector:

In some of the portable chargers provided herein, the power source takes the form of one or more photovoltaic cells. The use of photovoltaic cells as a power source makes it possible to easily recharge the battery almost anywhere the card holder happens to be. Incorporating the photovoltaic cells into a separate portable charger, rather than into the electronically readable card, allows the electronically readable card itself to remain as lightweight and flexible as possible. In addition, should the cells fail or otherwise need replacement, the present design requires only that the charger be replaced and not the card. The photovoltaic cells may take the form of thin, flexible solar cells. A plurality of cells may be arranged in an array on the surface of a connector and may be coupled in series or in parallel. For example, the cells may be mounted on a sleeve connector or on either the connection surface of a base plate connector or on a cover of a base plate connector. Suitable solar cells for use with the portable chargers provided herein are described in U.S. Pat. Nos. 5,853,498 and 6,124,545, the entire disclosures of which are incorporated herein by reference.

In other embodiments, the power source takes the form of a battery. The battery is desirably a thin, flexible battery and may be a primary or a secondary battery. The battery may be of the same type as the secondary battery integrated into the electronically readable card including the polyimide batteries noted above, wherein polyimide can be found in the electrolyte, an electrode, or both. The advantage of using a separate battery as a power source in the portable chargers is that a larger battery having a higher charge capacity may be used. This will tend to made the chargers somewhat larger, heavier and less flexible than the electronically readable card. However, since the electronically readable card is easily charged and removed from the charger, the inconvenience of this added bulk is only temporary. Yet the charger itself commonly remains only slightly less portable than the electronically readable card. Like the photovoltaic cells, the battery of the portable charger may be arranged mounted on or embedded in the connector of the charger.

Power Sources—Remote Power Outlets:

In another design, the power source takes the form of a direct plug connection to a remote power outlet, such as a 110 V wall socket, a Universal Serial Bus (USB) port or a telephone jack. These types of power outlets have been used to recharge batteries in small electronic devices, such as cell phones and hand-held computers. However, until now, the use of such outlets to charge the batteries in an electronically readable card has been impractical because electronically readable cards do not come equipped with plugs. By integrating a plug with a connector, such as a sleeve, a clip or a base plate, the convenience of power outlet based battery charging is made accessible for electronically readable cards. In these embodiments, the connector typically includes a plug that is adapted to mate with a complimentary socket (e.g. wall socket, USB port or phone jack). The plug may be attached directly to the connector or may be connected through a power cord. For example, when a USB port is used to power the charger, the connector typically includes a USB plug in electrical communication with one or more electrical contacts on the connector. In some embodiments, the portable chargers include a voltage regulator coupled between the connector of the charger and the remote power supply. USB powered battery chargers (including appropriate recharging circuitry) that may be incorporated into the portable electronically readable card chargers provided herein are described in U.S. Pat. Nos. 6,507,172 and 6,184,652 the entire disclosures of which are incorporated herein by reference.

When a telephone jack is used as the remote power outlet, the connector typically includes a telephone line attached to a telephone plug in electrical communication with one or more electrical contacts on the connector. Of course, the telephone line may be optional, with the telephone plug attached directly to the connector. Power is provided to the electrical contacts through the telephone jack when the plug is inserted into the jack. Once connected, the secondary battery of an electronically readable card secured by the connector may be recharged from power available from the telephone jack by means of either a DC rectification circuit or an AC rectification circuit which may be incorporated into the connector or installed in the telephone line. Suitable DC and AC rectification circuits for use in providing recharging power from telephone lines are described in U.S. Pat. No. 5,982,862, the entire disclosure of which is incorporated herein by reference.

Inductive Charging Embodiments:

In an alternative embodiment, power from the portable charger is transmitted to the secondary battery of an electronically readable card through a contactless interface via inductive coupling. In this embodiment, recharging takes place via an inductive link between the portable charger and the secondary battery of the electronically readable card. In one variation of this embodiment, the portable charger incorporates a primary winding of a transformer (i.e. a primary coil), a power amplifier and a power connection (e.g. a power cord and/or plug) that may be plugged into an AC power outlet. The power amplifier amplifies power obtained from the power outlet and outputs that power to the primary winding for inductive transfer to an electronically readable card. The electronically readable card incorporates a secondary winding (i.e. a secondary coil) connected in parallel with a rectifier circuit, the output of which is in electrical communication with the secondary battery of the electronically readable card. When the electronically readable card is secured to the connector, the primary and secondary winding are placed in close proximity and become inductively coupled, such that amplified signals from the primary winding induce corresponding signals in the secondary winding. The rectifier circuit is used to control the direct current such that it remains at a level appropriate to charge the secondary battery. A suitable example of an inductive coupling battery charging system that may used with the portable chargers provided herein is described in U.S. Pat. No. 5,455,466, the entire disclosure of which is incorporated herein by reference.

Power Interfaces:

In addition to the power source for recharging the secondary battery of an electronically readable card, the portable charger may also include a power interface for regulating and transferring power from the power source to the secondary battery. The power interface includes the circuitry necessary for delivering power from the power source to one or more electrical contacts on the connector that engage electrical contact pads on the electronically readable card when the electronically readable card is secured to the connector. In its simplest form, the power interface is simply a power line extending from the power source to the contacts. Optionally, the power line may include a power amplifier, a power converter and/or other circuitry responsive to the battery voltage to limit the current delivered from the power source to the battery. Generally such circuitry can include an appropriate resistor. In some embodiments, the power interface may include a diode between the power source and the electrical contacts to prevent discharge of the battery back into the power source.

Biometric Sensors:

Biometric sensors may also be integrated into the portable chargers, the electronically readable cards, or both. These sensors may be used to confirm that the holder of an electronically readable card is an authorized card user. These sensors generate an electrical representation of a biometric characteristic (e.g. a fingerprint) and transmit that signal to the microprocessor of an electronically readable card through a communications interface. The microprocessor compares the electrical representation to a stored representation to determine whether the holder is an authorized user and, if so, to unlock the information stored on the card. The communications interface may be a contact interface that includes, for example a bus, for transmitting the electrical signal to the microprocessor. Alternatively, the communications interface may be a contactless interface that transmits and receives wireless signals, such as Bluetooth, radiosignals, infrared signals or that operates by capacitive or inductive coupling.

Although it is possible to integrate biometric sensors into an electronically readable card, doing so can increases the size and weight of the electronically readable card and can result in the electronically readable card being equipped with a relatively large internal power supply. One option is to power the biometric sensor from the connector such as the sleeve. Integrating the biometric sensor into the portable charger, on the other hand, provides a portable sensor for unlocking the electronically readable card without actually affecting the size and shape of the electronically readable card itself. In addition, the charger may be equipped with a larger battery than the electronically readable card. Biometric sensors include, but are not limited to, fingerprint sensors, voice recognition sensors, retinal scanner and face scanners. Examples of biometric sensors that may be integrated into the recharging sleeve are described in U.S. Pat. No. 6,547,130, the entire disclosure of which is incorporated herein by reference.

Multiple Power Sources:

Some of the portable battery chargers provided herein may include more than one power source. For example, the portable chargers may incorporate a combination of batteries, solar cells, and remote power connections (e.g. power cords/plugs). In addition, the portable chargers may include both contact type charging components and contactless, inductive coupling type components. When more that one power source is present, it may be desirable to include a switch on the portable charger (e.g. on the connector) that allows the user to direct the power from one power source or another into the secondary battery of an electronically readable card. In one exemplary embodiment, a connector, such as a sleeve, includes a secondary battery embedded in or mounted to the sleeve housing as a primary power source and a secondary power source (e.g. a plug connection to a direct power outlet or photovoltaic cells) that is connected to the battery through appropriate charging circuitry. In this embodiment the secondary power source may be used to charge the secondary battery of the portable charger and the secondary battery of the portable charger may, in turn, be used to charge the secondary battery in an electronically readable card. In a further variation on this embodiment a switch may be included in the portable charger to direct the power from the secondary power source to either the secondary battery of the portable charger or directly to the secondary battery in an electronically readable card secured by the connector.

Illustrative Embodiments/Figures

Several illustrative embodiment of the portable charges are described with reference to the drawings, below. These embodiment are intended only to exemplify the portable charges and should not be interpreted as limiting the invention.

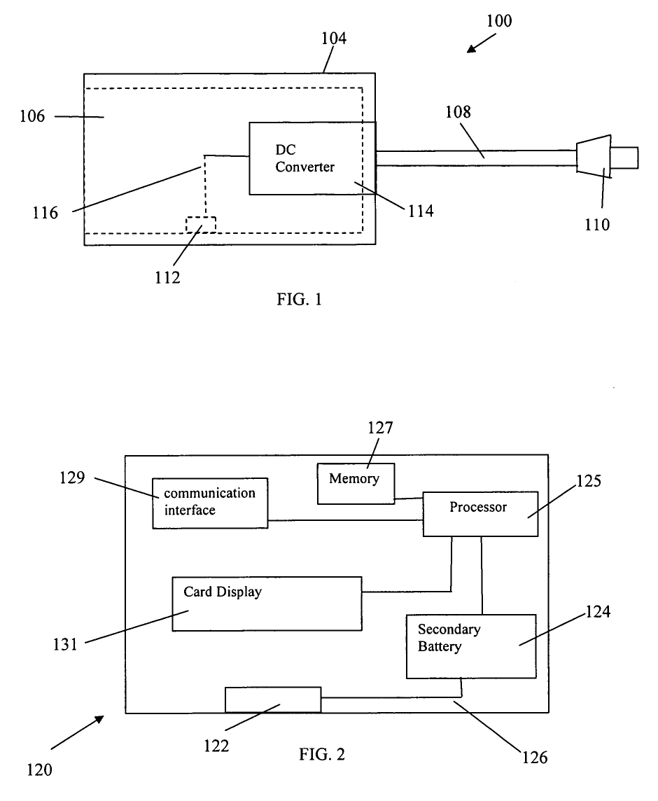

FIG. 1 shows a portable charger 100 in sleeve form. The connector of the charger 100 is a sleeve type connector which includes a housing 104 that defines a slot 106 (dashed line). The connector further includes a USB cord 108 with a USB plug 110 attached to the housing 104. The cord 108 is in electrical communication with an electrical contact 112 in the slot 106. The electrical contact is in electrical communication with the USB cord 108 through a DC converter 114 and a connecting wire 116. The DC converter converts the voltage transmitted from a USB port (e.g. typically delivered at +5V and 0.5 A) to a voltage and current appropriate for the secondary battery of an electronically readable card. Such converters are well known and commercially available. FIG. 2 shows an electronically readable card adapted to be charged with the portable charger of FIG. 1. As shown in this figure, the electronically readable card 120 includes a contact pad 122 along one edge. (Note: the electronically readable card is not drawn proportionally with respect to the portable charger. Instead, it is enlarged for the sake of clarity.) The pad is in electrical communication with a secondary battery 124 in the card 120 through a connecting wire 126. In the card illustrated in FIG. 2, the secondary battery 124 powers a processor 125 which is interfaced with the card memory 127, a communication interface 129 and a card display 131. When the card 120 is slid into the slot 106 the electrical contact pad 122 engages the electrical contact 112 such that power may be delivered from a remote USB port (not shown) to the battery 124.

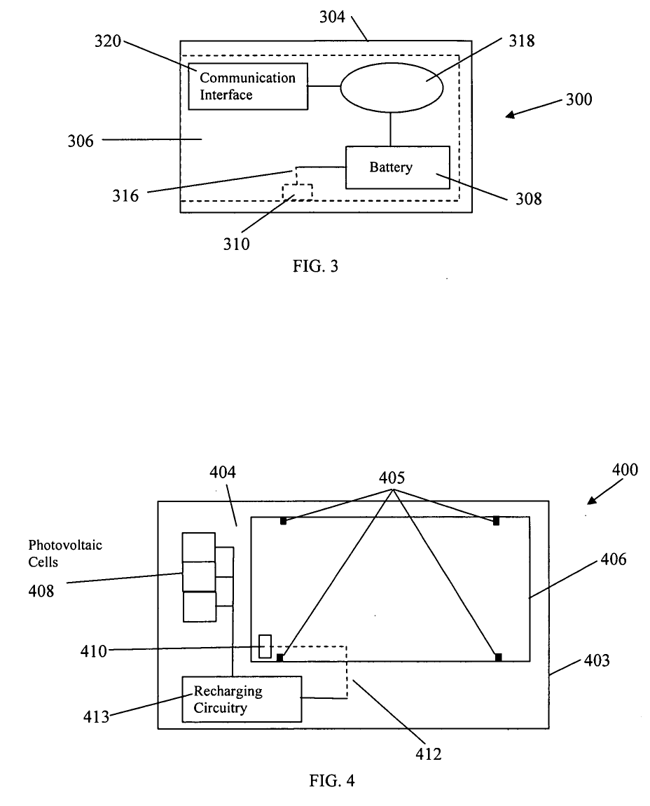

FIG. 3 shows a portable charger 300 with a biometric sensor. The connector of the charger 300 is a sleeve type connector which includes a housing 304 that defines a slot 306 (dashed line). The connector further includes a battery 308 embedded in the housing 304. The battery 308 is in electrical communication with an electrical contact 310 in the slot 306 through a connecting wire 316. A fingerprint sensor 318 is mounted on the housing 304. The fingerprint sensor 318 is in electrical communication with and powered by the battery 308. In addition the fingerprint sensor 318 is in electrical communication with a communication interface 320 through which biometric data may be transmitted to a microprocessor in an electronically readable card. Thus, the battery on the portable charger of FIG. 3 serves the dual purpose of powering the fingerprint sensor and charging a secondary battery on an electronically readable card. If desired, a switch may be provided to selectively direct the power from the battery to either the biometric sensor or the electrical contact as necessary. The electronically readable card shown in FIG. 2 could be used with the portable charger of FIG. 3.

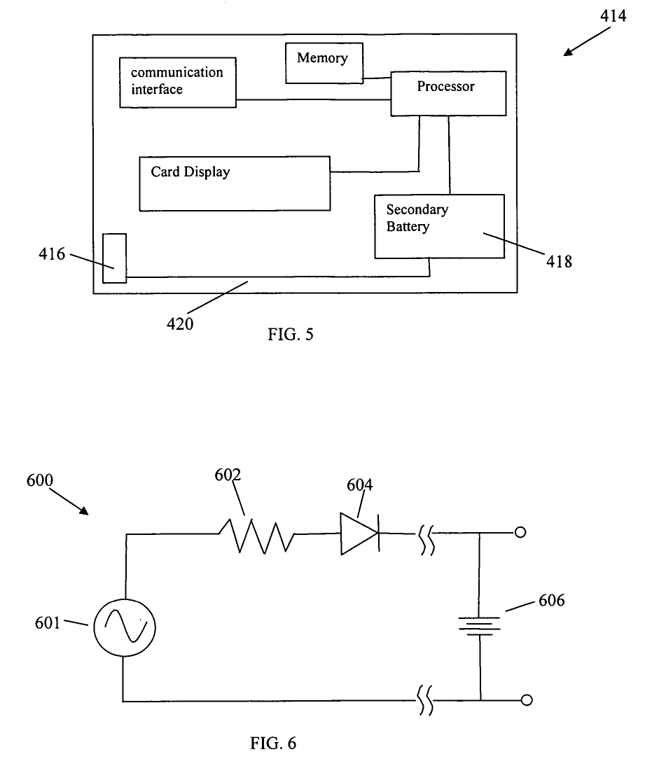

FIG. 4 shows a portable charger 400 having a base type design. The connector of the charger 400 includes a base plate 403 having a connection surface 404 which defines an indentation 406 into which an electronically readable card may be secured (e.g. snapped). As illustrated in FIG. 4, tabs 405 extending over the indentation 406 may be used to snap over and secure an electronically readable card when that card is pressed onto the base plate 403. A plurality of photovoltaic cells 408 are mounted to the connection surface 404 of the base 403. The photovoltaic cells 408 are in electrical communication with an electrical contact 410 in the indentation 406 through connecting wires 412 and recharging circuitry 413. FIG. 5 shows an electronically readable card adapted to be charged with the portable charger of FIG. 4. (Note: the electronically readable card is not drawn proportionally with respect to the portable charger. Instead, it is enlarged for the sake of clarity.) The electronically readable card of FIG. 5 differs from that of FIG. 2 only in the placement of the contact pad 416 which is now located on one surface of the card, rather than along a card edge. The contact pad 416 is in electrical communication with a secondary battery 418 in the card 414 through a connecting wire 420. When the card 414 is snapped into the indentation 406 the electrical contact pad 416 engage the electrical contact 410 such that power may be delivered from the photovoltaic cells 408 to the battery 418.

FIG. 6 shows an example of a recharging circuit 600 that may used in conjunction with the photovoltaic cells of FIG. 4 and other power sources, including contactless, inductively coupled power interfaces, as described in greater detail below. The recharging circuit is designed to receive power from an AC power source 601 (e.g. AC power outlet) and convert it into power having a suitable voltage and current to charge a secondary battery in an electronically readable card. The recharging circuitry includes a current limiting resistor 602 rectified by a diode 604 and in electrical communication across a secondary battery 606 in an electronically readable card. A recharging circuit of this type is described in U.S. Pat. No. 5,300,875, the entire disclosure of which is incorporated herein by reference.

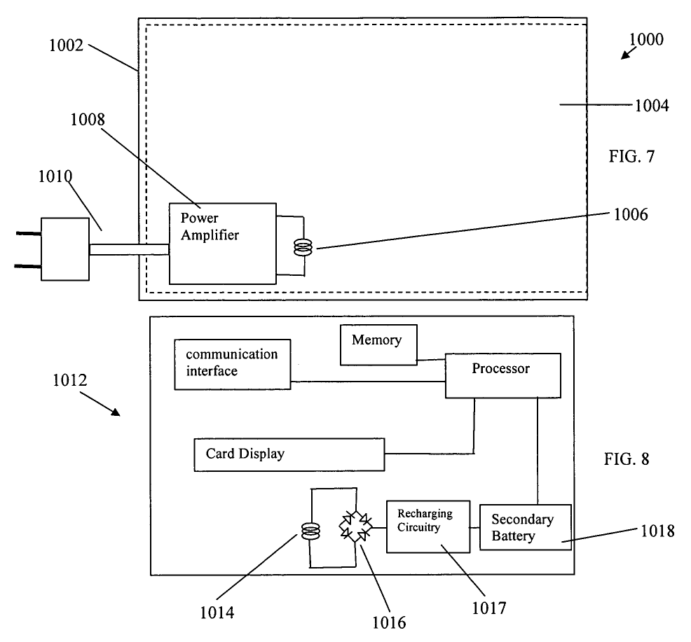

FIG. 7 shows a portable charger 1000 that uses inductive charging to charge a battery in an electronically readable card. As shown in the figure, the portable charger 1000 includes a sleeve connector 1002 that defines a slot 1004 (dashed line) into which an electronically readable card may be at least partially inserted. The sleeve 1002 incorporates a primary coil 1006 and a power amplifier 1008 into its housing. An AC power cord with plug 1010 is attached to the sleeve 1002. The power amplifier amplifies power obtained through the AC power cord 1010 from an AC power outlet (not shown) and outputs that power to the primary coil for inductive transfer to an electronically readable card. FIG. 8 shows an electronically readable card 1012 that may be charged with the portable charger 1000 of FIG. 7. The electronically readable card 1012 incorporates a secondary coil 1014 connected in parallel with a rectifier circuit 1016, the output of which is in electrical communication with a recharging circuit 1017 which is itself in electrical communication with the secondary battery 1018 of the electronically readable card 1012. The recharging circuit may be of the type shown in FIG. 6. In this case, the recharging circuit 1017 is located on (or in) the electronically readable card, rather than on the connector as in FIG. 4. When the electronically readable card 1012 is secured in the slot 1004, the primary and secondary coils are placed in close proximity and become inductively coupled, such that amplified signals from the primary winding induce corresponding signals in the secondary winding.

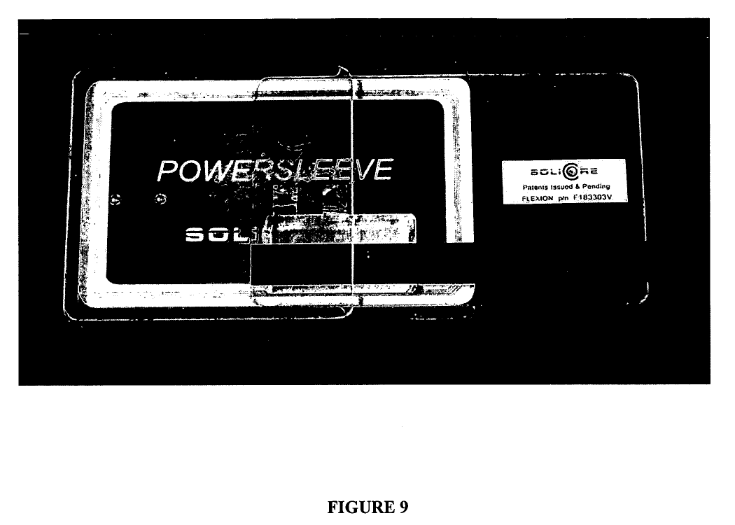

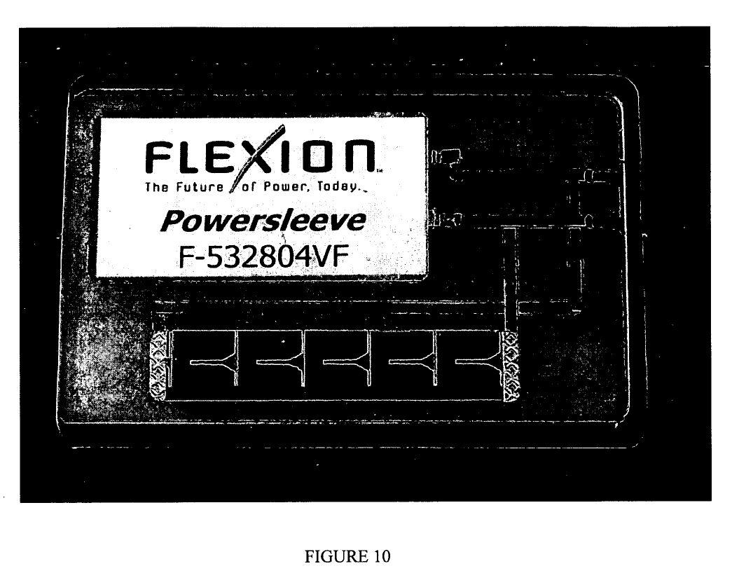

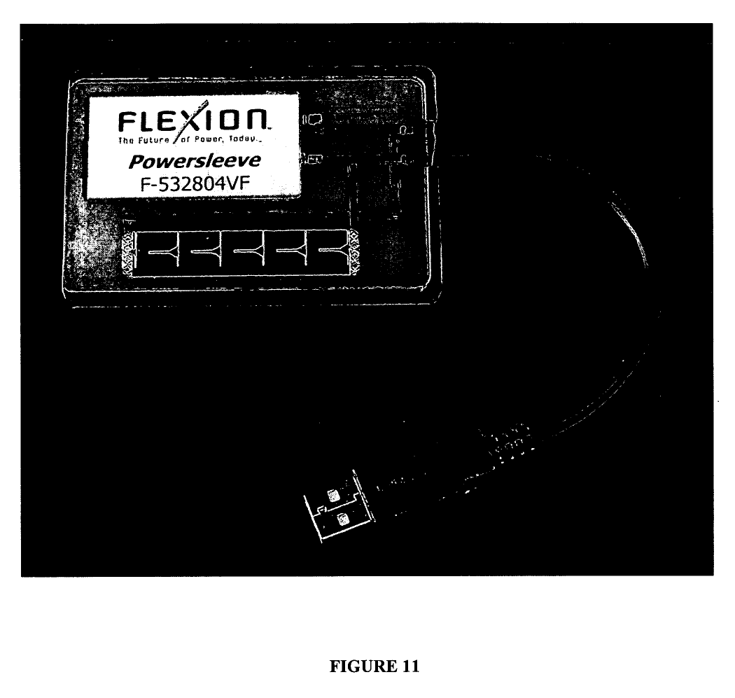

FIGS. 9, 10, and 11 show mock-up versions of the sleeve type of connector, using transparent materials.

Technical Literature

The following references describe various aspects of battery recharging and electronically readable card technology and can be referred to in the practice of the invention and are incorporated by reference in their entirety. For example, U.S. Pat. No. 6,507,172 describes a universal serial bus powered battery charger intended for use in battery powered hand-held and other portable devices. U.S. Pat. No. 5,300,875 describes passive, non-contact recharging of secondary battery cells. U.S. Pat. No. 5,777,903 describes solar powered smart cards. U.S. Pat. No. 6,325,285 describes smart cards with integrated fingerprint readers. U.S. Pat. No. 6,547,130 describes integrated circuit cards with fingerprint verification capability. U.S. Pat. No. 6,644,548 describes an apparatus for reading and writing a memory card. U.S. Pat. No. 6,694,399 describes a device for universal serial bus smart card traffic signaling. U.S. Patent publication 2003/0098355, published May 29, 2003, describes a dual battery configuration to provide long-term power for programmable smart cards. U.S. Pat. No. 5,677,568 describes thin IC cards wherein the battery is embedded using an expandable resin to make the card surface flat. U.S. Pat. No. 6,109,530 describes electronically readable cards which can comprise chip-battery micromodules in compact, rigid structures. U.S. Pat. No. 6,694,399 describes electronically readable cards and readers for same. Still other U.S. patents which relate to readers and components for electronically readable cards include, for example, 6,564,995; 6,543,690; 6,439,464; 6,343,364; 6,308,317; 6,308,270; 6,157,966; 6,098,891; 6,078,898; and 5,509,073. All of these patents are incorporated herein by reference in their entirety.

The invention has been described with reference to various specific and illustrative embodiments. However, it should be understood that many variations and modifications may be made while remaining within the spirit and scope of the invention.

1. A portable charger for an electronically readable card having a rechargeable battery, the charger comprising:
(a) a connector comprising at least one electrical contact; and
(b) a power source in electrical communication with the at least one electrical contact; wherein the at least one connector is positioned such that it forms an electrical connection with a matching contact pad on an electronically readable card when the electronically readable card is secured by the connector.

2. The portable charger of claim 1 wherein the connector comprises a sleeve which defines an internal slot adapted for face or edge connection with the electronically readable card.

3. The portable charger of claim 1 wherein the connector comprises a sleeve which defines an internal slot adapted for face connection with the electronically readable card.

4. The portable charger of claim 2 wherein the sleeve comprises a plastic sleeve.

5. The portable charger of claim 2 wherein the sleeve has a thickness of no more than about 5 mm, a width of no more than about 10 cm and a length of no more than about 15 cm.

6. The portable charger of claim 2 wherein the sleeve has a thickness of no more than about 4 mm, a width of no more than about 8 cm and a length of no more than about 12 cm.

7. The portable charger of claim 1, wherein the power source comprises a battery.

8. The portable charger of claim 1 wherein the power source comprises one or more photovoltaic cells.

9. The portable charger of claim 1 wherein the power source comprises a remote power outlet and the connector comprises a plug adapted to engage the remote power outlet.

10. The portable charger claim 9 wherein the remote power outlet comprises a 110 V outlet, a USB port or a telephone jack.

11. The portable charger of claim 2, wherein the power source is a battery embedded in the sleeve.

12-21. (canceled)

22. A portable charger for an electronically readable card, the charger comprising:
(a) a connector for securing an electronically readable card;
(b) a primary coil connected to the connector;
(c) a power connection for delivering power from a remote power outlet to the primary coil; and
(d) a power amplifier in electrical communication with the power connection;
wherein the primary coil is positioned such that it is inductively coupled to a secondary coil on an electronically readable card when the electronically readable card is secured by the connector.

23. The portable charger of claim 22 wherein the connector comprises a base comprising a connection surface adapted to secure an electronically readable card and the primary coil is disposed on the connection surface.

24. The portable charger of claim 23 wherein the connector further comprises a cover adapted to fit over an electronically readable card when the electronically readable card is secured to the connection surface.

25. The portable charger of claim 22 wherein the connector comprises a sleeve which defines an internal slot and the primary coil is disposed on the sleeve.

26. The portable charger of claim 22, further comprising a biometric sensor integrated into the connector.

27. The portable charger of claim 26 wherein the biometric sensor is a fingerprint sensor.

28-37. (canceled)

38. A portable charger for an electronically readable card, the charger comprising a power sleeve comprising (i) at least one electrical contact adapted for contact or non-contact transmission of power to the electronically readable card; and (ii) a power source in electrical communication with the at least one electrical contact, wherein the power sleeve is about 4 mm in thickness or less and has a volume ratio between the volume of the power sleeve and the volume of the electronically readable card of 5:1 or less.

39. The portable charger according to claim 38, wherein the volume ratio is about 2:1 or less.

40. The portable charger according to claim 38, wherein the power sleeve is adapted for data transmission with the electronically readable card.

41-43. (canceled)
